(19) United States
(12) Patent Application Publication
(10) Pub. No.: US 2024/0322312 A1
(43) Pub. Date: Sep. 26, 2024

(54) Battery Housing

(71) Applicant: Mercedes-Benz Group AG, Stuttgart (DE)

(72) Inventors: Andreas SCHURZ, Aichelberg (DE); Stefan RIEDLINGER, Kirchheim (DE)

(21) Appl. No.: 18/561,564

(22) PCT Filed: Dec. 8, 2022
(86) PCT No.: PCT/EP2022/085040

§ 371 Date: Nov. 16, 2023

(30) Foreign Application Priority Data
Dec. 16, 2021 (DE) 10 2021 006 213.2

(51) Int. Cl. H01M 50/166; H01M 50/159

(52) U.S. Cl. CPC H01M 50/166; H01M 50/159

(57) ABSTRACT

A battery housing includes a first housing part and a second housing part that are connected to one another via a screw. The first housing part has a threaded bushing with a thread that is connected to the first housing part. The second housing part has a through hole. The screw is disposed through the through hole and in the threaded bushing. The threaded bushing is at least partially made of a material that melts, softens, or breaks down during a thermal event.

### BACKGROUND AND SUMMARY OF THE INVENTION

The invention relates to a battery housing having a lower housing part and a housing lid of the kind defined in more detail herein.

Battery housings for traction batteries that deliver the electrical drive power for at least partially electrically driven vehicles are fundamentally known from the prior art. To be able to service the battery within the battery housing, these battery housings are generally constructed from at least two housing parts that are connected to one another via screws, for which purpose a through hole is formed in one of the housing parts and a thread is formed in the other housing part, for example in order to correspondingly screw the housing lid to the lower housing part or indirectly to components connected to the lower housing part.

In such a housing, safety for the battery also always plays a decisive role. If, for example, a so-called thermal event takes place, in which one or more of the individual battery cells in the battery housing overheat and consequently emit hot gases and/or combustible particles, it must be ensured that excess pressure in the battery housing can be reduced, for example via a rupture disc, a pressure relief valve or the like. In this context, reference can be made purely by way of example to DE 10 2019 100 094 A1, which shows a membrane for degassing a battery housing in combination with a pressure relief valve. Any hot gases that arise are then diverted in a targeted manner via the pressure relief valve, typically into a region in which they can only cause little damage. This entire process in the event of a thermal event, which is also referred to as a thermal runaway, is typically referred to as venting for releasing gases.

In the case of a screwed battery housing, the problem can arise that screwed connections of the housing part can become detached in the event of such a thermal event, and gas can then be released uncontrollably into the environment. This relates in particular to screwed connections via which, for example, a battery lid is screwed to corresponding elements within the battery housing to stabilise the latter over the surface. If an extreme excess pressure arises here, then the screwed connections can be destroyed, which is typically associated with leakages arising in the region of the through holes despite the sealing screws typically used. If gases, in particular combustible gases, escape here, then in the worst case scenario the corresponding through hole can also be further torn open or opened further due to the effect of the heat, such that even more gases reach the environment in an uncontrolled manner. This should be avoided.

Reference can also be made to DE 10 2007 060 081 B4 as further prior art, which shows a two-part thermoplastic threaded bushing that can be used for any screwed connections.

The object of the present invention is to disclose a battery housing that guarantees increased safety, and in particular prevents the disadvantages described above with regard to a potential leakage in the region of the screwed connections.

The battery housing according to the invention comprises two housing parts that are connected to one another via several screws. The housing parts can for example be a lower housing part and a housing lid. One of the housing parts, in particular the lower housing part in the specified exemplary embodiment, has threads to receive the screws protruding through the through holes of the other housing part, and thus in particular the housing lid here. According to the invention, the threads are in the form of threaded bushings. These threaded bushings are connected to the one housing part via screws or in a form-fit manner and have a thread for receiving the screw. It is the case that the threaded bushings are at least partially made of a material that melts or breaks down during a thermal event within its proximity. The material of the threaded bushing can thus be designed continuously or at least partially such that in the event of a thermal event in the proximity of the screwed connection, precisely this screwed connection fails. A predetermined breaking point is thus created, such that the screw is torn out of its thread, but the through hole and the screw are not damaged. The situation can thus be created that although the lid detaches as a whole, in particular in a central region from the other housing part, the through openings remain closed, as the screws are not moved any further. The battery housing can thus be kept sealed as a whole. The optionally bulging housing lid as one of the housing parts that now loses its central fixing via some of the screws can even help to alleviate the pressure increase in the battery housing via the resulting enlargement in the internal volume of the battery housing, such that corresponding safety elements, such as rupture discs or the like for diverting the gases into a venting conduit in a targeted manner have sufficient time to react.

The threaded bushing itself can preferably be made of two materials, wherein according to a very advantageous development of the battery housing according to the invention, the threaded bushing has a metallic material and a thermoplastic material. This combination of metal and thermoplastic plastic, for example a thermoplastic polymer, allows a simple and efficient production, for example by an inner part of the threaded bushing made of metal being placed in an injection moulding machine and being correspondingly overmoulded with the further part of the threaded bushing. Now, if a thermal event arises, the thermoplastic material will correspondingly break down, melt or at least soften to a point where this part of the threaded bushing can no longer withstand the forces and the screwed connection fails as a predetermined breaking point in the desired manner.

According to a very advantageous development of the battery housing according to the invention, the metallic material can comprise the thread for the screw, while the thermoplastic material comprises the connection to the other housing part. This construction is particularly efficient. The screw can engage with the metallic part of the threaded bushing in order thus to ensure that the screw, and optionally a seal located between the threaded bushing and the screw or between the screw head and the housing part remains in its position. The relative position of the screw in relation to the metallic part of the threaded bushing thus will not change in the event that the predetermined breaking point is activated, such that the through hole in the housing part having the screw remains reliably closed. The connection to the other housing part via the thermoplastic material will fail from a particular temperature and/or a particular pressure onwards, as the thermoplastic material cannot receive such strong forces as the metallic material and does not withstand such high temperatures. The predetermined breaking point can thus be shifted directly into the region of the connection on the second housing part, such that the failure arises exactly in the desired region.

The connection of the threaded bushing to the second housing part can thus be implemented in a form-fit manner, such that the threaded bushing is almost worked into the housing part and, via corresponding beads made of the thermoplastic material or the like running between the two form-fit elements, is held in the latter. This is sufficient for transmitting the forces arising in the normal operation and leads to the correspondingly desired failure as a predetermined breaking point in the event of a thermal event.

As an alternative to the latter, according to a further embodiment of the battery housing according to the invention, the connection can also be designed as a thread. This has the advantage that the threaded bushings can be produced independently of the lower part or second part of the battery housing. They can then be screwed into a thread of this second housing part before the other housing part is laid on top and is screwed to the threaded bushings via the screws, and thus indirectly to the other housing part.

According to a very advantageous development of the battery housing according to the invention, the screw itself can be designed as a screw that provides a seal in relation to the housing part having the through hole, as has already been specified above. As an addition or, principally, as an alternative to the latter, in the battery housing according to the invention, a seal can further be provided between the screw and the threaded bushing, which seal consists of a thermally resistant material and can thus maintain its function in the event of a thermal event, and does not melt or break down.

In a further exceptionally favourable embodiment of the battery housing according to the invention, it can further be provided that a flange of the threaded bushing is formed on the side facing the through hole. If the seal described according to the embodiment just described is present, the latter can be received between the housing part and precisely this flange, and reliably seals the construction. If, furthermore, the threaded bushing is designed such that the metallic material of the threaded bushing comprises the thread for the screw, this part will also correspondingly comprise the flange, such that such a seal is also reliably held between the housing part and the threaded bushing in the event that the predetermined breaking point is activated, and thus also reliably seals the through hole in the event that the predetermined breaking point is activated.

The housing part having the through hole can preferably, but not necessarily, be a housing lid, the housing part having the thread can be designed as a lower housing part, which for example has this thread continuously around a flange or, also in relation to the surface of the lower part of the thread, centrally on corresponding tension rods that protrude through battery modules in the battery housing or are at least indirectly held by such battery modules.

Further advantageous embodiments of the battery housing according to the invention result from the exemplary embodiment, which is described in more detail in the following with reference to the figures.

### BRIEF DESCRIPTION OF THE DRAWINGS

FIG. 1 shows a screwed connection according to the invention between housing parts of a battery housing in an embodiment according to the invention; and

FIG. 2 shows the screwed connection according to FIG. 1 after a thermal event has occurred.

### DETAILED DESCRIPTION OF THE DRAWINGS

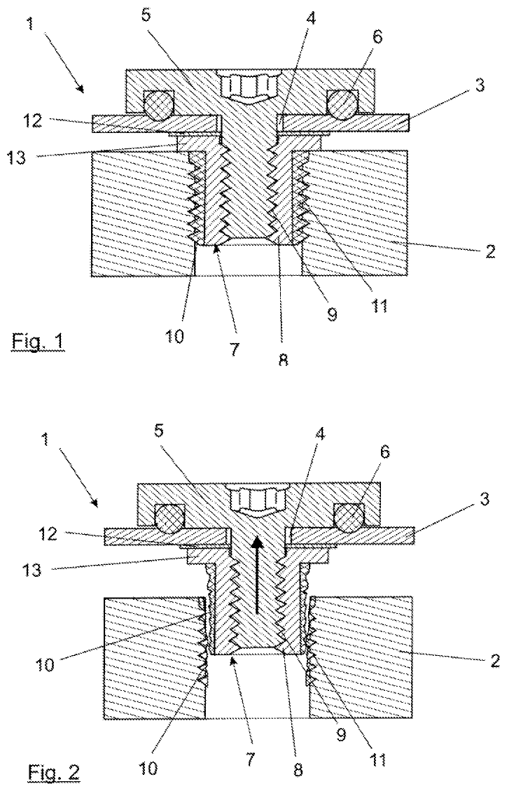

In the depiction of FIG. 1, a portion of a battery housing 1 relevant to the invention is depicted in a possible embodiment according to the invention. The battery housing 1 comprises a first housing part 2 that is designed as a lower housing part and a second housing part 3 that is here implemented as a housing lid 3. The housing lid 3 has a through hole 4 for a screw 5 for screwing the housing lid 3 to the lower housing part 2. The screw 5 is designed as a so-called sealing screw that guarantees that the through hole 4 will be sealed between the screw head and the housing lid 3 via a continuous seal 6.

The thread for fixing the screw 5 to the lower housing part 2 is designed in the form of a threaded bushing 7. In the exemplary embodiment depicted here, this threaded bushing 7 consists of an inner part 8 made of a metallic material having a through bore and a thread labelled with 9 here for receiving the screw 5 or the thread of the screw 5.

The threaded bushing 7 additionally comprises an outer portion labelled with 10, which is produced from a thermoplastic plastic, for example in which the inner part 8 of the threaded bushing 7 is overmoulded with this thermoplastic plastic. The adherence of the thermoplastic plastic on the inner part 8 can be implemented purely via adhesion or adhesive bonding, but, although this is not depicted here, form-fit connecting elements could also be provided. The outer periphery of the outer part 10 made of the thermoplastic plastic then forms a thread 11 in turn, which is correspondingly screwed into the thread of the second housing part 2. The construction is such that a sufficient fixing of the housing lid 3 in relation to the lower housing part 2 with a good seal is generated.

To improve the sealing with regard to the through hole 4 even further, a seal 12 can additionally be provided, which seals this region, preferably by being clamped between the housing lid 3 and a flange 13 of the threaded bushing 7, wherein this flange 13 is preferably designed as part of the inner part 8 of the threaded bushing 7, and is thus made from the metallic material.

If a thermal event then arises in the environment of the described screwed connection within the battery housing 1, then the pressure in the battery housing 1 on the one hand and the temperature on the other will rise. After a certain amount of time or from a certain limit pressure onwards, a rupture disc or the like will then typically open to release the excess pressure and the dangerous and possibly burning gases into a region of the environment selected in a targeted manner. To prevent an undesired escape of the gas from arising, in particular through the through holes 4 in the battery lid 3, the described construction of the threaded bushing 7 is now provided. The thermoplastic material 10 of the threaded bushing 7 represents as it were a predetermined breaking point in the event of excess pressure, in particular in combination with an increased temperature due to a thermal event. The thermoplastic material 10 melts or is broken down or softened. The melted or the softened material can then no longer withstand the pressure between the lower part 2 and the battery lid 3, such that the outer region of the threaded bushing 7 fails and the latter detaches from the lower housing part 2. In the depiction of FIG. 2, the construction shown in FIG. 1 is depicted in the event of such a failure of the thermoplastic plastic material 10 of the threaded bushing 7. The battery lid 3 can thus bulge slightly, and thus increase the volume in the interior of the battery housing 1 and alleviate the pressure increase. Above all, however, in the event of such a thermal event and/or excess pressure, it is ensured via the targeted failure in the region of the threaded bushing 7 that the screw 5 remains reliably positioned on the lid 3 and thus that the through opening 4 remains reliably sealed, such that no gases can escape here.

The seal 12 remains clamped between the flange 13 of the temperature-resistant inner part 8 of the threaded bushing 7 and the housing lid 3, the screw 5 remains in its position and can thus reliably seal the through hole 4 via the seal 6 in addition to the seal 12. The entire housing lid 3 is lifted from the lower housing part, however, due to the failure of the thermoplastic material 10 of the threaded bushing 7. If, for example, these screwed connections are used in a sheet-metal lid, the latter would bulge to achieve the effect already described above. In any case, it can be achieved via this kind of screwed connection via the specific threaded bushing 7 that an undesired escape of gases and, optionally, flames through the through holes 4 of the screwed connection is reliably prevented.

The components of FIG. 2 have the same reference numerals as the analogous components of FIG. 1. The construction of the lid 3, the inner part 8, the threaded bushing 7 and the screw 5 that is raised in relation to the housing part 2 is correspondingly symbolized by the arrow. The thermoplastic plastic material 10 of the threaded bushing 7 is partially still adhered to the inner part 8 of the threaded bushing 7 and partially still in the region of the thread 11. For clarification, this thermoplastic material is provided with the reference numeral 10 in both positions.

1.-10. (canceled)

11. A battery housing (1), comprising:
a first housing part (2); and
a second housing part (3), wherein the first housing part (2) and the second housing part (3) are connected to one another via a screw (5), wherein the first housing part (2) has a threaded bushing (7) with a thread (9) that is connected to the first housing part (2), wherein the second housing part (3) has a through hole (4), and wherein the screw (5) is disposed through the through hole (4) and in the threaded bushing (7);
wherein the threaded bushing (7) is at least partially made of a material (10) that melts, softens, or breaks down during a thermal event.

12. The battery housing (1) according to claim 11, wherein the threaded bushing (7) has a metallic material and a thermoplastic material (10) arranged concentrically.

13. The battery housing (1) according to claim 12, wherein the metallic material comprises the thread (9) and the thermoplastic material (10) forms a connection to the first housing part (2).

14. The battery housing (1) according to claim 13, wherein the connection is a form-fit connection.

15. The battery housing (1) according to claim 13, wherein the connection is a thread (11).

16. The battery housing (1) according to claim 11, wherein the screw (5) provides a seal in relation to the second housing part (3).

17. The battery housing (1) according to claim 11, further comprising a seal (12) made of a thermally resistant material that is disposed between the threaded bushing (7) and the second housing part (3) and around the through hole (4).

18. The battery housing (1) according to claim 11, wherein the threaded bushing (7) has a flange (13) on a side facing the second housing part (3).

19. The battery housing (1) according to claim 11, wherein the second housing part (3) is a housing lid (3).

20. The battery housing (1) according to claim 11, wherein the first housing part (2) is a lower housing part (2).
